(19) United States
(12) Patent Application Publication
(10) Pub. No.: US 2008/0198022 A1
(43) Pub. Date: Aug. 21, 2008

(54) Inkjet printable RFID label and method of printing an inkjet printable RFID label

(75) Inventors: Kevin G. Battles, Wahpeton, ND (US); Stephen L. Bradley, Oak Park Heights, MN (US); G. Phillip Rambosek, Shafer, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/709,511

(22) Filed: Feb. 21, 2007

(51) Int. Cl. G08B 13/14

(52) U.S. Cl. 340/572.8

(57) ABSTRACT

An inkjet printable RFID label includes an RFID tag having a backing and RFID circuitry coupled to the backing, and a laminate coupled to the backing and covering the RFID circuitry, where the laminate includes an inorganic inkjet receptive surface. The inkjet receptive surface enables printing ink directly to the laminate atop the RFID circuitry.

### THE FIELD OF THE INVENTION

Aspects relate to an RFID enabled label, and, more particularly, to an inkjet printable RFID enabled label including an inkjet receptive laminate.

### BACKGROUND

Data storage devices have been used for decades in computer, audio, and video fields for storing large volumes of information for subsequent retrieval and use. Data storage devices continue to be a popular choice for backing up data and systems.

Data storage devices include data storage tape cartridges, hard disk drives, micro disk drives, business card drives, and removable memory storage devices in general. These data storage devices are useful for storing data and for backing up data systems used by businesses and government entities. For example, businesses routinely backup important information such as human resource data, employment data, compliance audits, and safety/inspection data. Government sources collect and store vast amounts of data related to taxpayer identification numbers, income withholding statements, and audit information. Congress has provided additional motivation for many publicly traded companies to ensure the safe retention of data and records related to government required audits and reviews after passage of the Sarbanes-Oxley Act (Pub. L. 107-204, 116 Stat. 745 (2002)).

Collecting and storing data has become a routine good business practice. In this regard, the data can be generated in various formats by a company or other entity, and a backup or backups of the same data is often saved to one or more data storage devices that is/are typically shipped or transferred to an offsite repository for safe/secure storage. Occasionally, the backup data storage devices are retrieved from the offsite repository for review and/or updating. The transit of data storage devices between various facilities introduces a possible risk of misplacing the devices. Businesses have an interest in identifying each device and the data stored on each device to facilitate tracking of the backup data storage devices during transit, and thus minimizing the risk of misplacing or losing the backup data storage devices.

With the above in mind, identification labels are typically attached to an exterior of each newly manufactured or refurbished data storage device. The labels generally provide some form of identifying printed information that can be read by a human, and can also include printed data suited for reading by an optical reader. Since label printing equipment suited for printing cartridge labels is expensive, cartridge manufacturers typically order labels from an outside printing vendor.

The known printed cartridge labels include some form of a plastic film coating (an overcoat) to prevent smearing of the printing. Such cartridge labels are generally printed on a color thermal printer or laser printer (associated with high temperature printing and high pressure printing), laminated with a plastic film, die cut to size, and shipped in sheet form back to the cartridge manufacturer. Cartridge labels can be expensive. In addition, if even one printed label in the order is incorrect, the entire order may need to be reproduced, which can lead to a manufacturing delay.

Physical data security and provenance is a growing concern for users of data storage devices. Manufacturers are interested in systems and/or processes that enable tracking of data storage devices. To this end, improvements to the labeling of data storage devices will benefit both public and private business sectors.

### SUMMARY

One embodiment provides an inkjet printable RFID label including an RFID tag having a backing and RFID circuitry coupled to the backing, and a laminate coupled to the backing and covering the RFID circuitry, where the laminate includes an inorganic inkjet receptive surface. The inkjet receptive surface enables printing ink directly to the laminate atop the RFID circuitry.

Another embodiment provides a sheet including a plurality of RFID labels. The sheet includes a release liner and an adhesive layer in contact with the release liner, an array of RFID tags contacting the adhesive layer, and label stock disposed over the RFID tags. Each RFID tag includes a backing and RFID circuitry attached to the backing. The label stock includes a second adhesive coupled to the backing of the RFID tag opposite of the adhesive layer, a substrate coupled to the second adhesive, and an inkjet receptive surface disposed on the substrate spaced from the second adhesive.

Another embodiment provides a method of inkjet printing an RFID label. The method includes providing an RFID tag including a backing defining a first surface and a second surface, radiofrequency circuitry attached to the second surface, and an inkjet receptive laminate attached to the first surface. The method additionally includes inserting the RFID tag as a component of an inkjet printable label stock into an inkjet printer, and inkjet printing indicia onto an inkjet receptive surface of the inkjet receptive laminate of the label stock.

Another embodiment provides a sheet including a plurality of volser labels attachable to a data storage cartridge. The sheet includes a release liner, and volser labels removably coupled to the release liner. Each volser label includes an adhesive in contact with the release liner, a substrate coupled to the adhesive, and an inkjet receptive surface disposed on the substrate spaced from the adhesive. In this regard, the inkjet receptive surface comprises inorganic particles coated onto the substrate to define a porous inkjet receptive surface.

### BRIEF DESCRIPTION OF THE DRAWINGS

The accompanying drawings are included to provide a further understanding of the present invention and are incorporated in and constitute a part of this specification. The drawings illustrate example embodiments and together with the description serve to explain principles of the invention. Other embodiments and many of the intended advantages of the embodiments will be readily appreciated as they become better understood by reference to the following detailed description. The elements of the drawings are not necessarily to scale relative to each other. Like reference numerals designate corresponding similar parts.

FIG. 1 is a top view of a sheet of inkjet printable RFID labels according to one embodiment;

FIG. 2 is a cross-sectional view of one of the inkjet printable RFID labels illustrated in FIG. 1;

FIG. 3 is a bottom view of the inkjet printable RFID label illustrated in FIG. 2 showing RFID circuitry;

FIG. 4 is a top view of the inkjet printable RFID label illustrated in FIG. 2 showing an inkjet receptive surface;

FIG. 5 is a perspective view of an inkjet printable RFID label attached to a data storage device according to one embodiment;

FIG. 6A is a perspective view of another embodiment of an inkjet printable laminate and an RFID tag attachable to a data storage device;

FIG. 6B is a perspective view of an inkjet printable laminate attachable to a data storage device according to one embodiment;

FIG. 7A is a perspective view of a sheet of inkjet printable RFID labels insertable into an inkjet printer according to one embodiment; and

FIG. 7B is a perspective view of a sheet of inkjet printable volser labels insertable into an inkjet printer according to one embodiment.

### DETAILED DESCRIPTION

Embodiments provide an inkjet printable RFID label suited for being printed by a commodity inkjet printer. The inkjet printable RFID labels provide line of sight reading of indicia inkjet printed onto the label, provide an inkjet printed barcode configured for high speed optical scanning, and include an RFID tag configured for wireless reading of data stored on a chip of an RFID tag of the label. In one embodiment, the inkjet printed indicia on the inkjet printable RFID label is waterfast, i.e., is water resistant and resists smearing, and does not need a film overcoat to maintain the waterfastness. The inkjet printable RFID label need not be waterfast. The inkjet printable RFID labels are compatible with standard, commodity inkjet printers, such that one or more of the labels can be conveniently and inexpensively inkjet printed without risking damage to circuitry of the RFID tag within the label.

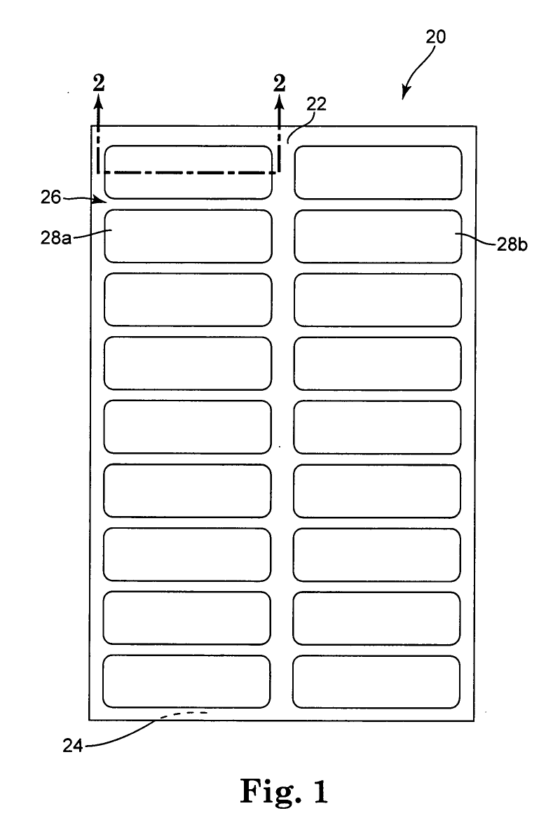

FIG. 1 is a top view of a sheet 20 of inkjet printable RFID labels according to one embodiment. The sheet 20 includes RFID label stock adhesively attached to a release liner 24, where the RFID label stock 22 includes an array 26 of removable inkjet printable RFID labels 28a, 28b. Each of the inkjet printable RFID labels 28 is configured to be removed from the release liner 24 and separated from the sheet for placement on a device, such as a data storage device or a carton containing multiple data storage devices.

Although the array 26 illustrates two columns of nine RFID labels 28 each, the array 26 could include fewer than two columns or more than two columns having any suitable number of RFID labels 28 provided in each column. Each of the inkjet printable RFID labels 28 includes some form of memory for the storage of electronic data, and some form of an antenna to enable communication with the RFID label 28.

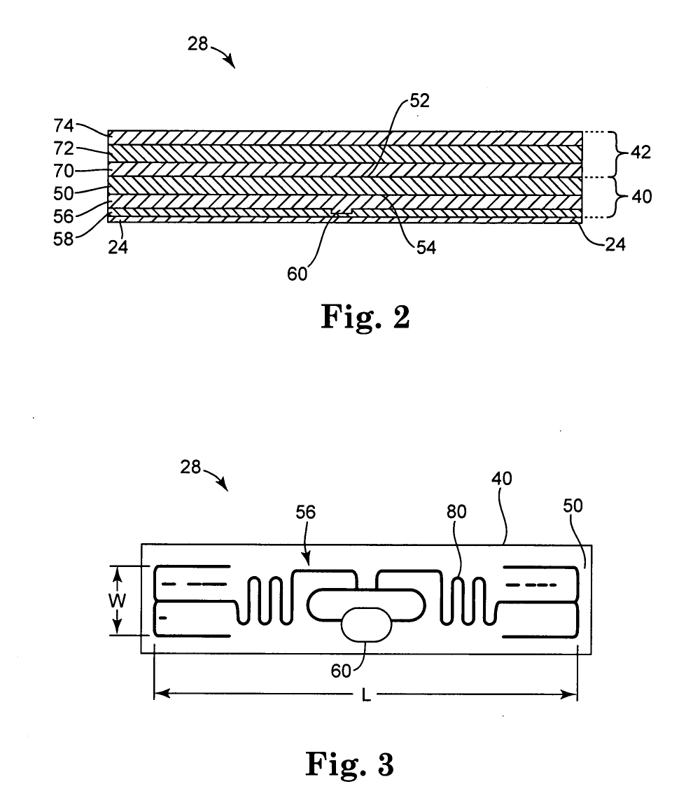

FIG. 2 is a cross-sectional view of the inkjet printable RFID label 28. The RFID label 28 includes the release liner 24 in contact with an RFID tag 40, which is in contact with an inkjet receptive laminate 42.

The release liner 24 can include any suitable release liner configured to releasably separate from an adhesive surface and can include silicone coated substrates and the like.

The RFID tag 40 includes a backing 50 that defines a first surface 52 and a second surface 54, radiofrequency circuitry 56 attached to the second surface 54, and an adhesive layer 58 adjacent to the second surface 54.

In one embodiment, the backing 50 provides a carrier for the circuitry 56 and adhesive 58. In this regard, one embodiment of the backing 50 provides a substrate suitable for receiving conductive ink of a printed style circuit. Suitable materials for the backing 50 include cellulosic materials or polymer materials, such as films. For example, in one embodiment the backing 50 is a polyester backing to which two or more layers of a metal foil are adhered. The metal foils are etched to form an antenna (described below), a capacitor, and integrated circuit (IC) pads. Suitable connections are made between the foil layers and one or more integrated circuits via anisotropic conductive adhesives, or the like.

The circuitry 56 is generally printed or wired or disposed on one of the surfaces 52, 54 of the backing 50. In one embodiment, a memory chip 60 projects out of the circuitry 56 and away from the second surface 54 of the backing 50 to define a prominence. In one embodiment, the adhesive 58 is coated over the memory chip 60 as illustrated in FIG. 2.

The adhesive 58 is selected to enable attachment of the RFID label 28 to a surface (such as a carton surface or a cartridge surface) after the liner 24 is removed. In this regard, the adhesive 58 is preferably tacky at room temperature. Suitable adhesives 58 include pressure sensitive acrylate adhesives, such as poly-butyl-acrylate or poly-2-ethylhexyl-acrylate adhesive, UV-curable adhesives such as Dymex 488, temperature or moisture cured adhesives, and/or reactive adhesives, such as epoxies.

The inkjet receptive laminate 42 includes a separate adhesive 70, a substrate 72, in contact with the adhesive 70, and an inkjet receptive surface 74 in contact with the substrate 72.

The separate adhesive 70 can assume a variety of forms, and is selected to ensure that the inkjet receptive laminate 42 is bonded with integrity to the RFID tag 40. In one embodiment, the adhesive 70 is selected such that the substrate 72 will not peel relative to the RFID tag 40 along its edges when subjected to temperature changes from about minus 35 degrees C. to about 70 degrees C., and relative humidities on the order of about 70 percent RH to about 95 percent RH.

Suitable adhesives 70 include acrylate-based adhesives, such as poly-butyl-acrylate or poly-2-ethylhexyl-acrylate adhesive, UV-curable adhesives such as Dymex 488, temperature cured adhesives, moisture cured adhesives, and/or reactive adhesives, such as epoxies.

In one embodiment, the substrate 72 can be any of those normally employed with inkjet receptors, such as paper, resin-coated paper, plastics such as polyester terephthalate (PET) or polyester naphthalate (PEN), polyethylene, polypropylene, polyolefins in general, vinyl chloride resins, polycarbonates, various glass materials, and known microporous materials. Antioxidants, antistatic agents, plasticizers and/or other known additives can be incorporated into the substrate 72, if desired. In one embodiment, it is preferred that the substrate 72 is formed from a synthetic scrim (i.e., scrim comprised of a polymer) or a polymeric film(s) (e.g., polyethylene, polypropylene, polyester terephthalate, vinyl chloride, etc.) as opposed to paper (i.e., defined to be greater than 10% cellulose fiber by weight) because synthetic scrims and polymeric films are less likely to absorb moisture as compared to paper. Such scrims minimize the differential rates of dimensional change between the inkjet receptive laminate 42 and the backing 50, and thus minimize the possibility of delamination of the inkjet receptive laminate 42 from portions of the label 28.

In one embodiment, the substrate 72 has a suitable thickness and is configured such that the inkjet receptive laminate 42 is flexible. While the substrate 72 is illustrated in FIG. 2 as being a single material layer, in alternative embodiments, the substrate 72 can include two or more layers.

In one embodiment, the inkjet receptive surface 74 is formed as a coating on the substrate 72 (e.g., coating, drying, and curing of one or more solutions and/or dispersions). With this approach, the inkjet receptive surface 74 can include known inkjet receptive materials, such as inorganic particles (e.g., silica, alumina, etc.), a binder, such as polyvinyl alcohol, polyvinyl pyrrolidinone, polyvinyl acetate, polyethyl-oxazoline, and/or gelatin to name but a few. The inkjet receptive surface 74 can also contain organic beads or polymeric micro-porous structures without inorganic filler particles. In one embodiment, when cured, the inkjet receptive surface 74 forms a nanoporous surface configured to absorb inks, such as inkjet printed ink, under capillary action without swelling or dimensional changes. While the inkjet receptive surface 74 is shown in FIG. 1 as being a single layer, in alternative embodiments, the inkjet receptive surface 74 can consist of two or more layers.

The inkjet receptive laminate 42 is preferably highly white or silver, as described below. As such, the substrate 72, the inkjet receptive surface 74, or both, can include a filler material such as titanium dioxide, barium sulfate, calcium carbonate, aluminum oxide, and/or silicon dioxide to name but a few.

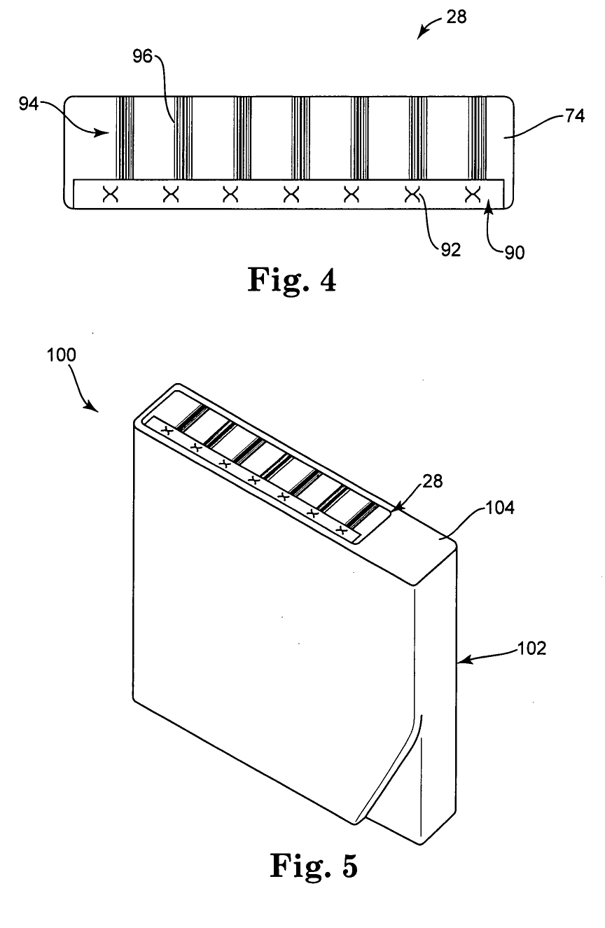

FIG. 3 is a bottom view of the inkjet printable RFID label 28 removed from the release liner 24 (FIG. 1), where the adhesive 58 has been removed to better illustrate the circuitry 56 of the RFID tag 40. The circuitry 56 includes the memory chip 60 and an antenna 80 configured to enable wireless communication by a device with the memory chip 60.

In one embodiment, the RFID tag 40 is an EPC class 1 RFID tag configured to be programmed and/or read by software operated by a wireless reader system. In another embodiment, the RFID tag 40 is an ultra high frequency (UHF) tag. Other forms of the RFID tag 40 are also acceptable, such as high frequency (HF) tags.

As a point of reference, when the RFID tag 40 is a passive RFID tag, it does not employ its own power source. In this regard, the passive RFID tag is “powered” whenever access to the tag is initiated by a reader system. For example, when a reader unit queries the RFID tag, an alternating current in an antenna of the reader induces a current in the antenna 80 of the passive RFID tag 40. This magnetically induced current in the RFID tag 40 enables the tag 40 to send and/or receive data. With this in mind, in one embodiment the RFID tag 40 is a passive RFID tag having a practical read range of less than approximately 6 feet (about 2 meters). The passive RFID tag preferably responds to a field less than 1 A/m, and has a resonant frequency near 13.56 MHz. To this end, in one embodiment the memory chip 60 is a radio frequency memory chip and includes a radio frequency interface (not shown) to support a nearby, contactless access to/from the memory.

In one embodiment, the memory chip 60 is configured to store information into a plurality of data fields, for example, such as a format of data printed on surface 74 and/or a volser number associated with the label 28. In one embodiment, the memory of the memory chip 60 stores a subset of data that is present on the surface 74 of label 28. In an alternative embodiment, the memory of the memory chip 60 stores all data that is present on the surface 74 of label 28 and can include fields including a 64 bit unique TAG identifier, an 8 bit RFID revision level, an 88 bit user defined volser number, a 32 bit cyclic redundancy check (CRC) sum, a 160 bit manufacturer's serial number, a case and/or device identifying number, and other data fields. In another embodiment, the memory chip 60 stores different field information for different devices to which label 28 is attached.

To this end, the memory chip 60 is preferably an electronic memory chip having at least the memory capacity to be written with device information. In one embodiment, the memory chip 60 is an electronic memory chip capable of retaining stored data even in a power “off” condition, and is, for example, a 4 k-byte electrically erasable programmable read-only memory (EEPROM) chip known as an EEPROM chip available from, for example, Philips Semiconductors, Eindhoven, The Netherlands. In another embodiment, the memory chip 60 is a 1 k-byte EEPROM chip. Those with skill in the art of memory chips will recognize that other memory formats and sizes for the chip 60 are also acceptable.

In one embodiment, the antenna 80 is a coiled copper radio frequency (RF) antenna. In an alternate embodiment, the antenna 80 is integrated within the chip 60. In any regard, it is to be understood that other materials for, and various forms of, the antenna 80 are also acceptable. In general, the antenna 80 is configured to inductively couple with a wireless reader system to receive/send data. With this in mind, in one embodiment the antenna 80 is an RF antenna configured to communicate information stored on the chip 60 to a transceiver module (not shown) in a separate reader unit.

In one embodiment, the RFID tag 40 is employed in a 13.56 MHz RFID system and the antenna 80 has a reactance that produces a resonance of about 13.56 MHz. In this regard, for RFID circuits having a capacitance of 27 pF, the antenna coil and parallel capacitor have a reactance of about +j435 ohms, equivalent to an inductance of about 5.1 μH. Other IC capacitances require different antenna reactances to resonate at 13.56 MHz. To this end, other capacitances and antenna reactances for the RFID tag 40 are also acceptable. In one embodiment, the antenna 80 has a capacitance that is adjustable to tune the resident frequency. In another embodiment, the capacitance of the antenna 80 is laser trimmed.

It is desired that the RFID tag 40 be sized to fit within a perimeter of the label 28 (FIG. 1), and be sized to have an appropriate range for the antenna 80. In this regard, in one embodiment the circuitry 56 is optimally sized to be disposed within a boundary of the backing 50, and defines a width of W and a length L that approximates a perimeter of the antenna 80. The circuitry width W and the circuitry length L are sized and selected according to the size of the device to which they are attached. With this in mind, an exemplary width W is between about 5 mm-20 mm, and an exemplary length L is between about 50 mm-100 mm. One of skill in the art will recognize that the width W and the length L for the circuitry 56, and thus the antenna 80, is adjustable in order to provide a suitable read range between the wireless reader and the RFID tag 40. For coiled antennas used in high frequency tags, the larger the area of the coil, the larger the potential read range.

For example, one aspect of the antenna 80 provides a width W of about 15 mm and a length L of about 77 mm, resulting in an antenna area of about 1155 sq. mm. In this manner, the antenna 80 is provided with a sufficient range, while the RFID tag 40 is sized to fit beneath the label 28 (FIG. 1). In another exemplary embodiment, the antenna 80 is sized to have a width W of about 15 mm and a length L of about 62 mm, resulting in an antenna area of about 930 sq. mm. In other embodiments, the antenna 80 is sized to have a width W of about 8.8 mm and a length L of about 70 mm and has an antenna area of about 616 sq. mm, which is suited for attachment to devices having slim profiles. In yet another embodiment, the antenna 80 is sized to have a width W of about 15 mm and a length L of about 77 mm. The antenna dimensions set forth above are exemplary dimensions, as other antenna dimensions are also acceptable. Generally, the width W and the length L of the circuitry 56 are sized such that the antenna 80 is about 1 mm less in width and about 2 mm less in length in comparison to dimensions of the backing 50.

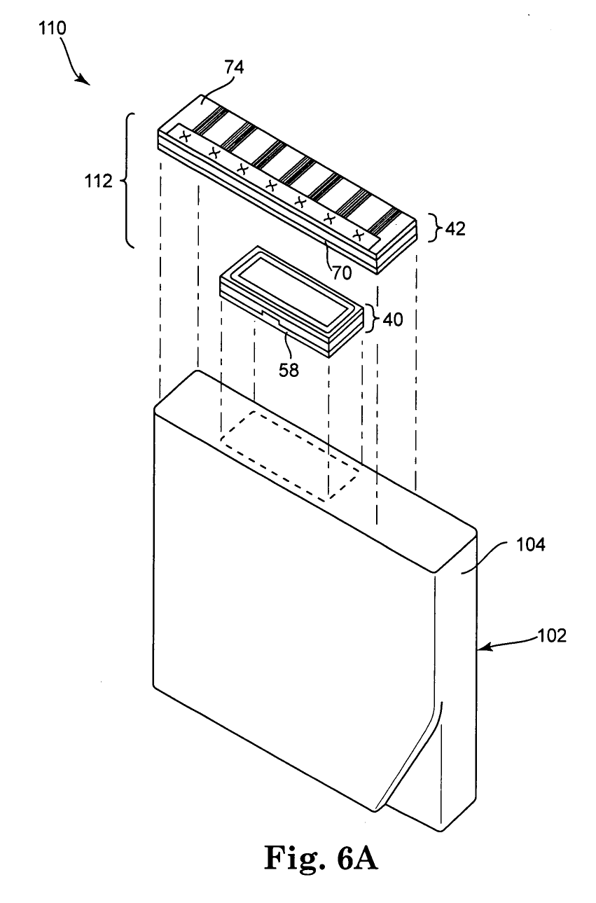

FIG. 4 is a top view of the inkjet printable RFID label 28. The top view of the RFID label 28 presents the inkjet receptive surface 74 oriented up relative to FIG. 4. In one embodiment, the inkjet receptive surface 74 includes a volser field 90 including volser data 92, and a bar code field 94 including optically scannable bar code data 96. In one embodiment, the volser data 92 includes a volser number that is a unique number specific to the device to which it is to be attached. In other embodiments, the volser number is a non-unique number. The volser number can be user-defined or assigned by a manufacturer according to specifications provided by a customer.

In general, the volser data 92 includes a volser number that correlates to an 88 bit field to mark the end of the volser number, which enables the reading and interpretation of variable length and/or unique volser numbers. In this regard, in one embodiment the volser number is printed as volser data 92 on the inkjet receptive surface 74, and the volser number is saved electronically on memory chip 60 (FIG. 3). The volser number can include a checking number in the volser field that verifies that the desired volser number has been correctly printed. The volser number can include an end mark character such as a NULL character, for example 8 bits of all binary zeros. As a point of reference, 8 bits of all binary zeros is the initial state of the memory, and also corresponds with a string termination character and the program language C/C++. In one embodiment, the bit pattern of the volser number is not encrypted when reading or writing the volser number to enable easy decoding by an outside source, such as a customer or a client. In other embodiments, the volser number is encrypted (for example by inverting the bits) to prevent decoding by an outside source, or encoded to save space in the memory of the memory chip 60. With this in mind, the memory chip 60 of the RFID tag 40 (FIG. 2) is typically programmed to include at least a subset of the data that is printed on the inkjet receptive surface 74. The memory chip 60 redundantly stores the data that is printed on the inkjet receptive surface 74 and enables wireless tracing of products to which the label 28 is attached.

The bar code data 96 includes bar code-scannable lines that are configured to enable the field 94 to be optically scanned. The inkjet printable RFID label 28 includes the volser field 90 and the bar code field 94 that provide line of sight reading of the label 28, bar code data 96 that enables optical scanning of the label 28, and the RFID tag 40 (FIG. 2) that enables radiofrequency reading of data stored on the memory chip 60 that correlates to some or all of the data printed on the inkjet receptive surface 74.

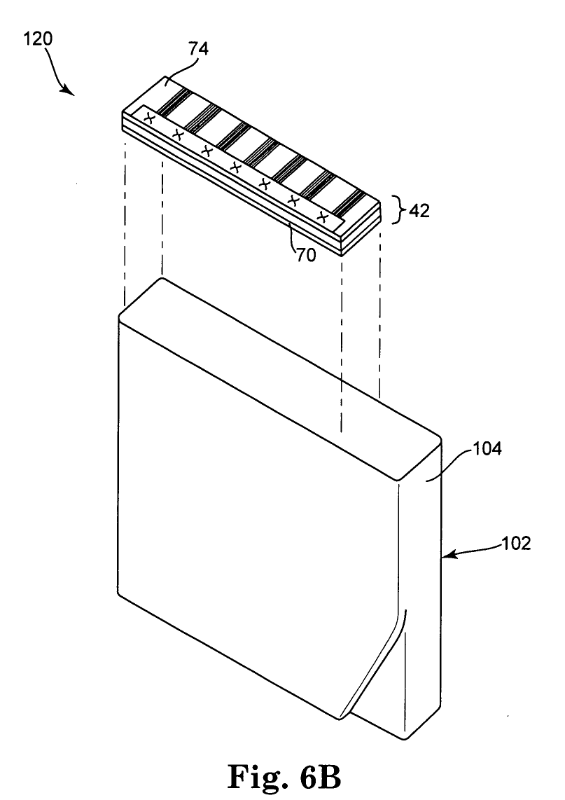

FIG. 5 is a perspective view of a data storage system 100 according to one embodiment. The data storage device tracing system 100 includes a data storage device 102 having a housing 104, and the inkjet printable RFID label 28 attached to the housing 104. The RFID label 28 enables optical and wireless identification of the data storage device 102 useful in tracking and/or tracing the device 102 during use/transport.

The data storage device 102 can include any suitable data storage device, such as non-portable data storage devices and portable data storage devices. Embodiments of the data storage device 102 include magnetic tape data storage cartridges, micro hard drives, hard disk drives, quarter inch cartridges, and scaleable linear recording cartridges to name several suitable examples.

With additional reference to FIG. 4, the data storage system 100 is compatible for use with a reader system (not shown) that is configured to wirelessly read the volser number from the memory chip 60 (FIG. 3) and/or optically read information from the inkjet receptive surface 74. In this regard, the label 28 is provided to uniquely identify the device 102 that it is attached to. When the reader system encounters the label 28, it queries the memory chip 60 and confirms or denies that the volser data 92 correlate to the bar code data 96, and that all data correlate to the specific device 102. In this regard, the reader system is configured to read the volser number and/or other data and trace the data storage device 102 as it enters and exits the reader system. Other embodiments of the data storage system 100 provide for the instantaneous and wireless radiofrequency cross checking of the data stored on the memory chip 60 as the data storage device 102 passes by the reader system.

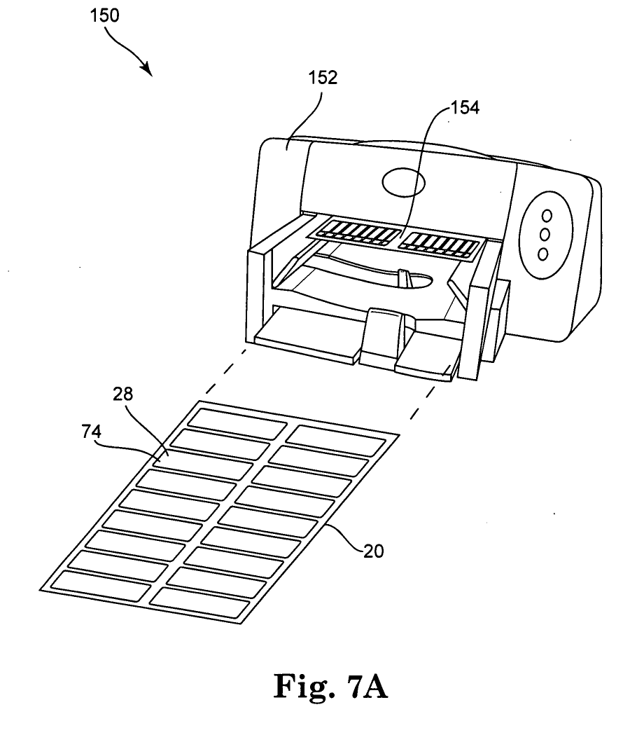

FIG. 6A is a perspective view of another data storage system 110 according to one embodiment. Data storage system 110 includes the data storage device 102 and the housing 104, and an inkjet printable RFID assembly 112 attachable to the housing 104. The inkjet printable RFID assembly 112 includes the RFID tag 40 that is attachable to the housing 104, and the inkjet receptive laminate 42 that is attachable over the RFID tag 40 and attachable to the housing 104. In one embodiment, the adhesive 58 of the RFID tag is adhered to the housing 104, and the separate adhesive 70 of the inkjet receptive laminate 42 is adhered to the RFID tag 40 and to the housing 104. In this regard, embodiments provide for separately inkjet printing the inkjet receptive surface 74 of the inkjet receptive laminate 42 prior to coupling the laminate 42 to the RFID tag 40.

FIG. 6B is a perspective view of a data storage system 120 according to one embodiment. Data storage system 120 includes the data storage device 102 and the housing 104, and the inkjet receptive laminate 42 that is attachable to the housing 104. In one embodiment, the RFID tag 40 (FIG. 6A) is optional or disposed on another portion of the device 102, and the adhesive 70 of the inkjet receptive laminate 42 is adhered directly to the housing 104. In this regard, embodiments provide for separately inkjet printing the inkjet receptive surface 74 of the inkjet receptive laminate 42 prior to coupling the laminate 42 to the housing 104.

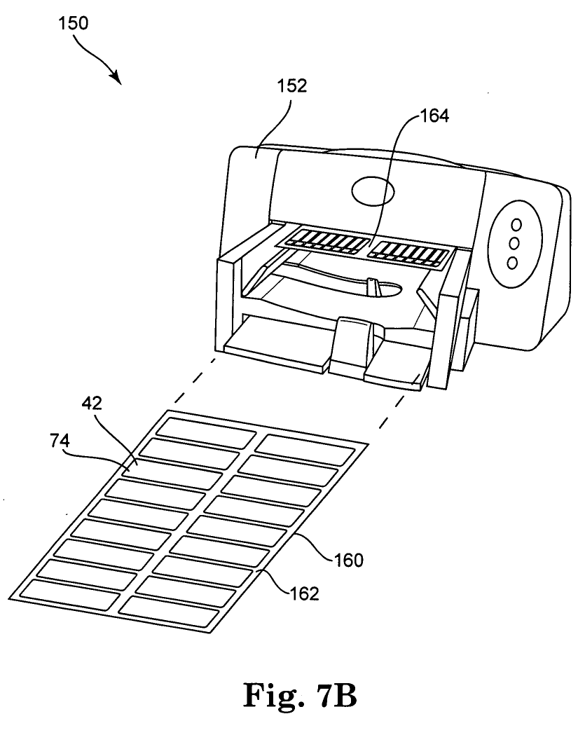

FIG. 7A is a perspective view of a system 150 for inkjet printing a sheet 20 of RFID labels 28. The system 150 includes an inkjet printer 152 configured to receive the sheet 20 and inkjet print the multiple separate inkjet receptive surfaces 74 on multiple labels 28. The inkjet print head (not shown) of the inkjet printer 152 is suited for inkjet printing indicia onto the receptive surface 74 without damaging the circuitry 56 (FIG. 2). In contrast, thermal printing of RFID enable labels has the potential to damage the RFID circuitry of the label, rendering the label useless (a situation that often is not discovered until the label is attached to a device).

Sheet 20 is fed into the inkjet printer 152, in a manner usual with desktop printing, and a printed sheet 154 of labels is produced. Each of the labels on the printed sheet 154 is similar to that illustrated for label 28 in FIG. 4 and includes the volser field 90 and the bar code field 94. With reference to FIGS. 1 and 2, the sheet 20 includes multiple RFID tags 40 distributed across the array 26. In one embodiment, each label 28 includes a unique volser number 92, and each memory chip 60 is electronically programmed with a range of data including at least the unique volser number 92 for that particular label 28. In another embodiment, each label 28 includes a user-specified volser number 92, and each memory chip 60 is electronically programmed with a range of data including at least the user-specified volser number 92 (which may not be a unique volser number) for that particular label 28. In an alternative embodiment, the labels 28 include a non-unique volser number 92, and the memory chips 60 are electronically programmed with a range of data including at least the volser numbers for that set of labels 28.

The sheet 20 enables a user to print information to the inkjet receptive surface 74 through the use of inexpensive and commonly available inkjet printers 152. Each of the labels 28 on the sheet 20 can be printed with different user-selected label data. For example, one of the labels 28 can be printed with a first volser number in the volser field 90 (FIG. 4), and another of the labels 28 can be printed with a different volser number in the volser field 90. The sheet 20 enables inkjet printing directly over the RFID tags 40 (FIG. 3) without risking damage to the circuitry 56 (FIG. 3). In addition, if a label 28 is incorrectly printed, another label 28 can be quickly and inexpensively printed by the inkjet printer 152.

In contrast, printed RFID enabled labels are assembled in a multi-step process that is selected to minimize the possible damage to the RFID circuitry associated with the thermal or laser printers used in printing. For example, known printed RFID enabled labels are made by first printing a paper label, laminating a protective film (for smear-resistance of the ink) over the printed paper label, and then attaching the paper/film printed label to an RFID tag.

FIG. 7B is a perspective view of the system 150 employed to inkjet print a sheet 160 of volser labels. The sheet 160 includes a release liner surface 162 to which multiple inkjet receptive laminates 42 are attached. The inkjet printer 152 is configured to receive the sheet 160 and inkjet print the multiple separate inkjet receptive surfaces 74 with at least the volser field 90 (FIG. 4).

Sheet 160 is fed into the inkjet printer 152, in a manner usual with desktop printing, and a printed sheet 164 of volser labels is produced. Each of the volser labels on the printed sheet 164 is similar to that illustrated for label 28 in FIG. 4 and can include the volser field 90 and the bar code field 94.

The inkjet receptive surface 74 offers various advantages over printed paper labels. In some embodiments, the inkjet receptive surface 74 has a low background density with high brightness and whiteness/silverness; is characterized by high levels of color saturation for all colors (i.e., C (cyan), M (magenta), Y (yellow), and K (CMY composite black)); provides sharp resolution of all colors against a white or silver background; provides sharp resolution of all colors as they adjoin/abut other colors—especially a CMY composite black; exhibits waterfastness (e.g., high resistance to color bleed or smearing when water droplets are wiped and/or blotted from the surface 74 and high resistance to color bleed when surface 74 is stored at high humidity as described below); exhibits resistance to color fade when surface 74 is exposed to light and/or heat (as determined by the UV fade testing described below); exhibits resistance to image loss due to scratching, abrasion, or marring; and exhibits high peel strength as described below. Some of these characteristics are quantified as follows:

### Dmin Value

Minimum color density (“Dmin Value”) is the color density of the inkjet receptive surface 74 prior to inkjet printing of indicia/images. An ideal “pure white” surface has a Dmin Value of 0. With this in mind, in one embodiment, the inkjet receptive laminate 42, when measured at the inkjet receptive surface 74, exhibits a Dmin Value of not more than 0.10, preferably not more than 0.07.

### Brightness Value

In some embodiments, the inkjet receptive laminate 42, when viewed at the inkjet receptive surface 74, is highly bright prior to inkjet printing. A “Brightness Value” of the surface 74 prior to printing can be determined as the average of percent reflectance of blue light directed onto the inkjet receptive surface 74 relative to a magnesium oxide reference, as measured at a wavelength at or about 457 nm, of four readings on the surface 74. An ideal “pure white” surface has a Brightness Value of 100%. With this in mind, in one embodiment, the inkjet receptive laminate 42, when measured at the inkjet receptive surface 74, exhibits a Brightness Value of at least 90%, preferably at least 95%, more preferably at least 100%.

### Whiteness (L* Value)

In some embodiments, the inkjet receptive laminate 42, viewed at the inkjet receptive surface 74, is highly white prior to receiving inkjet printing. A whiteness or “L* Value” of the laminate 42 at the surface 74 prior to printing can be determined by measuring L*a*b per CIELab color space definition using a densitometer/spectrometer (e.g., an X-Rite Model 528 densitometer/spectrometer), and is the average of eight points measured on the inkjet receptive surface 74. With this in mind, in one embodiment, the inkjet receptive laminate 42, when measured at the inkjet receptive surface 74, exhibits a L* Value of more than 95.0, preferably not less than 95.5, and more preferably not less than 96.0.

### Color Uniformity (ΔE Value)

In some embodiments, the inkjet receptive laminate 42, when viewed at the inkjet receptive surface 74, has a highly uniform color prior to receiving inkjet printing. A color uniformity or “ΔE Value” of the laminate 42 at the inkjet receptive surface 74 prior to inkjet printing is the distance between two points in the CIELab color space calculated using the following formula: sqrt((L₁−L₂)²+(a₁+a₂)²+(b₁+b₂)²), and is the range of eight points measured on the inkjet receptive surface 74. With this in mind, in one embodiment, the inkjet receptive laminate 42, when measured at the inkjet receptive surface 74, exhibits a ΔE Value of not more than 2.0, preferably not more than 1.75.

### Nitrogen Adsorption Value

In some embodiments, the inkjet receptive surface 74 is highly amenable to permanently retaining inkjet printed inks by providing an elevated nitrogen accessible adsorption area as compared to an apparent area of the surface 74. A Nitrogen Adsorption Value of the surface 74 can be defined as the ratio of the nitrogen accessible adsorption area to the apparent area of the surface as measured by the Brunauer-Emmett-Teller (BET) model. With this in mind, in one embodiment, the inkjet receptive surface 74 exhibits a Nitrogen Adsorption Value of greater than 0.2 m²/in², preferably greater than 0.4 m²/in², and more preferably greater than 0.8 m²/in².

### Inorganic Particle Loading Value

In some embodiments, the inkjet receptive surface 74 has a relatively significant inorganic particle loading for retaining inkjet printed inks. An Inorganic Particle Loading Value for the inkjet receptive surface 74 can be determined by measuring an initial weight of the inject receptive surface 74 as removed from the substrate 30, vaporizing the organic component of the inkjet receptive surface 74 in an appropriate device (e.g., a TGA tester), and then re-weighing the inkjet receptive surface 74. The Inorganic Particle Loading Value is then designated as a percentage, calculated by (Final Weight/Initial Weight)×100. With this in mind, in one embodiment, the inkjet receptive surface 74 exhibits an Inorganic Particle Loading Value of more than 15%, preferably more than 25%, preferably less than 75%, and preferably in the range of 15%-75%.

### Waterfast Optical Density Loss Percent Value

The inkjet receptive laminate 42 and, in particular, the inkjet receptive surface 74, is in some embodiments characterized as being waterfast, whereby inkjet printed indicia printed onto the surface 74 will not significantly degrade when exposed to water. This attribute can be quantified by comparing an optical density of inkjet printed indicia printed on the surface 74 before and after exposure to water. In particular, a Waterfast Optical Density Loss Percent Value can be determined by first creating 100% saturation color swatches for the primary colors of cyan (C), magenta (M), yellow (Y), CMY composite black (K or V), MY composite red (R), CY composite green (G), and CM composite blue (B) on the surface 74. 1957 USAF resolution test patterns are also imaged to the surface 74 in CMY composite black on white. The images are allowed to dry for three minutes and an optical density of the images is then measured. Because densities of various colors used will inherently differ, a composite or mean optical density value for all colors is determined (“Initial Composite Density”). Approximately 1 mil of deionized water is then placed on the CMYK color swatches. The water is allowed to stand for 10 seconds and then blotted off with a standard wipe cellulose-based art blotter. The blotter is not rubbed against the sample, but simply brought vertically into and out of contact with the sample surface. Blotter contact time is 2 seconds. Blotter pressure is 25 grams/square inch. The mean or composite color saturation density is then measured on both the sample surface (“Final Composite Density”) and on the blotter. A Waterfast Optical Density Loss Percent Value is then determined as: ((Initial Composite Density−Final Composite Density)/Initial Composite Density)×100. Alternatively, a Waterfast Optical Density Loss Value can be designated as the composite color saturation density of the blotter.

With the above in mind, in one embodiment, the inkjet receptive laminate 42, and in particular the inkjet receptive surface 74, exhibits a Waterfast Optical Density Loss Percent Value of not more than 10%, preferably not more than 7.5%, more preferably not more than 5%. In other embodiments, the inkjet receptive laminate 42, and in particular, the inkjet receptive surface 74, exhibits a Waterfast Optical Density Loss Value of not more than 0.4, preferably not more than 0.3, and more preferably not more than 0.2.

### UV Fade Optical Density Loss Percent Value

The inkjet receptive surface 74 is, in some embodiments, characterized as being UV fade resistant, whereby inkjet printed indicia printed onto the surface 74 will not significantly degrade when exposed to ultraviolet (UV) light. This attribute can be quantified by comparing an optical density of inkjet printed indicia printed on the surface 74 before and after exposure to UV light. In particular, a UV Fade Optical Density Loss Percent Value can be determined by first creating 100% saturation color swatches for the primary colors of cyan (C), magenta (M), yellow (Y), CMY composite black (K or V), MY composite red (R), CY composite green (G), and CM composite blue (B) on the surface 74. 1957 USAF resolution test patterns are also imaged to the surface 74 in CMY composite black on white. Once dried, a composite or mean optical density of the images is then measured (“Initial Composite Density”). The imaged sample is then placed 19 mm below the surfaces of two Sylvania F40/Daylight 6500 K, 2150 lumen initial output, 48 inch long/1 inch diameter, fluorescent light bulbs (Sylvania part number 24774) that are spaced by 55 mm, center-to-center. The combined UV power output of these two bulbs (for wavelengths less than 400 nm) is 0.688 watts. The white reflector enclosing the bulbs has an opening that provides a target area of 1858 cm², giving an area power density of 3.70×10⁻⁴ W/cm². Color saturation density is measured after 72-hours of UV exposure (“Final Composite Density”). The UV Fade Optical Density Loss Percent Value is then determined as: ((Initial Composite Density−Final Composite Density)/Initial Composite Density)×100.

With the above in mind, in one embodiment, the inkjet receptive laminate 42, and in particular the inkjet receptive surface 74, exhibits a UV Fade Optical Density Loss Percent Value of not more than 15%, preferably not more than 10%.

### Resolution Value

Relative resolution measurements are made by ranking the smallest legible feature on a standard printed 1951 USAF resolution test pattern. The rating is comprised of whole numbers followed by decimal fractions (e.g., −1.3). The whole numbers (those preceding the decimal place) describe sub-sets of the test pattern. As these numbers increase, the sub-sets are graduating to smaller feature sizes implying better resolution (e.g., −1.0 represents smaller features (better resolution) than −2.0). The decimal fraction of the rating describes the rank within a sub-set; larger numbers describe features of smaller size within a sub-set (e.g., −1.7 represents smaller features (better resolution) than −1.3). Thus, resolution ratings cannot be compared as though they were single numbers. The whole numbers of the ratings must first be compared as described. If these are equal, the decimal portions of the ratings are compared as a more refined discriminator. With this in mind, in one embodiment, the inkjet receptive laminate 42, and in particular the inkjet receptive surface 74, exhibits a Resolution Value of at least −1.5, more preferably at least −2.1, even more preferably at least −2.3.

### BFR Value

As described above, the inkjet receptive laminate 42 preferably exhibits high resistance to color bleed under normal and even extreme use or storage conditions. To this end, “bleed” can be evaluated according to the following test. Printed images are created on the inkjet receptive surface 74 using 100% color saturation of white, cyan (C), magenta (M), and yellow (Y) line patterns within a black (composite CMY) background. These patterns within the black background are referred to as white-on-black (W-B), cyan-on-black (C-B), magenta-on-black (M-B), and yellow-on-black (Y-B), respectively. Images are created using an HP Deskjet 5150 print engine and factory default driver settings with disabled enhancement options. Each color line pattern is comprised of four line widths: 2-point, 4-point, 8-point, and 16-point. The measured printed widths of these lines are 0.032 mm, 0.064 mm, 0.128 mm, and 0.256 mm, respectively. Line widths intermediate between these widths, larger than these widths, or smaller than these widths can also be constructed for improved test resolution/sensitivity/discrimination and/or increased range. Each line width of each color is printed having line directions oriented in the vertical, horizontal, 45° diagonal set at a positive slope with respect to horizontal, and 45° diagonal set at a negative slope with respect to horizontal. Line lengths are 4 mm. The high ink load of the composite black background tends to migrate (or “bleed”) into the colored line areas. As this occurs, the lines become occluded with black color. Black field resolution value (“BFR Value”) is estimated as the minimum line width (in units of points) for which less than 10% of any line length (i.e., any line in any direction) was completely occluded; that is, greater than 90% of the line length retained some visible width of the original line color (white, C, M, or Y) when viewed under 12 power magnification. A composite BFR Value is the average of the ratings for these four line color groups. Thus, a lower BFR Value represents better print quality.

With this test protocol in mind, and in accordance with one embodiment, the inkjet receptive laminate 42, and in particular the inkjet receptive surface 74, preferably exhibits a BFR Value of each individual line color group and/or a Composite BFR Value of all line groups of less than or equal to 30, more preferably a BFR Value or Composite BFR Value of less than or equal to 16, more preferably a BFR Value or Composite BFR Value of less than or equal to 8, even more preferably a BFR Value or Composite BFR Value of less than or equal to 4, even more preferably a BFR Value or Composite BFR Value of less than or equal to 2, and even most preferably a BFR Value or Composite BFR Value of less than or equal to 1. These preferred BFR Values and Composite BFR Values are, in one embodiment, exhibited under each and all of the following conditions: within 5-10 minutes after printing; 24 hours after printing (stored under room conditions of 18-20° C. and 35-65% RH); after 72 hours after printing an exposure to 40° C. and 85% RH; after 72-hours exposure to 55° C. and 85% RH; and after 72-hours exposure to 70° C. and 85% RH. It should be noted that “bleed” is herein technically most preferably defined as no increase in BFR Value or Composite BFR Value due to time and environmental effects (i.e., no change), second most preferably as an increase in BFR Value or Composite BFR Value due to time and environmental effects less than or equal to 100%, third most preferably as an increase in BFR Value or Composite BFR Value due to time and environmental effects less than or equal to 200%, fourth most preferably as an increase in BFR Value or Composite BFR Value due to time and environmental effects less than or equal to 400%, fifth most preferably as an increase in BFR Value or Composite BFR Value due to time and environmental effects less than or equal to 800%.

### Drying Time

In some embodiments, the inkjet receptive laminate 42, and in particular the inkjet receptive surface 74, is characterized by facilitating rapid drying of inkjet printed ink (under normal environmental conditions of 18-20° C. and 35-65% RH). By way of reference, inkjet printed onto a surface is considered “dry” when the printed ink is not transferred to a cotton swab when rubbed. With this in mind, in one embodiment, the inkjet receptive surface 74 is characterized as achieving, under normal environmental conditions, an inkjet printed ink drying time of less than 3 minutes, preferably less than 1 minute, and more preferably less than 30 seconds.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of inkjet printable RFID labels as discussed herein. Therefore, it is intended that this invention be limited only by the claims and the equivalents thereof.

What is claimed is:

1. An inkjet printable RFID label comprising:
an RFID tag including a backing and RFID circuitry coupled to the backing; and
a laminate coupled to the backing and covering the RFID circuitry, the laminate including an inorganic inkjet receptive surface;
wherein the inkjet receptive surface enables printing ink directly to the laminate atop the RFID circuitry.

2. The inkjet printable RFID label of claim 1, wherein the laminate comprises an adhesive coupled to a first surface of the backing and a substrate coupled to the adhesive opposite of the first surface of the backing such that the inkjet receptive surface is disposed on the substrate and spaced from the adhesive.

3. The inkjet printable RFID label of claim 2, wherein the substrate comprises a polymeric substrate and the inkjet receptive surface comprises inorganic particles coated onto a surface of the polymeric substrate.

4. The inkjet printable RFID label of claim 3, wherein the inorganic particles coated onto a surface of the polymeric substrate defines a porous surface configured to absorb inkjet printed ink and be waterfast.

5. The inkjet printable RFID label of claim 1, wherein the inkjet receptive surface is characterized by an absence of a film overcoat.

6. A sheet including a plurality of RFID labels, the sheet comprising:
a release liner and an adhesive layer in contact with the release liner;
an array of RFID tags contacting the adhesive layer, each RFID tag including a backing and RFID circuitry attached to the backing; and
label stock disposed over the RFID tags, the label stock including:
a second adhesive coupled to the backing of the RFID tag opposite of the adhesive layer,
a substrate coupled to the second adhesive,
an inkjet receptive surface disposed on the substrate spaced from the second adhesive.

7. The sheet of claim 6, wherein the substrate comprises a polymeric substrate and the inkjet receptive surface comprises inorganic particles coated onto the polymeric substrate to define a porous inkjet receptive surface.

8. The sheet of claim 6, wherein each RFID label comprises a volser field including volser data printed on the inkjet receptive surface over the RFID circuitry, and a bar code field including optically scannable bar code data printed on the inkjet receptive surface over the RFID circuitry.

9. The sheet of claim 8, wherein the volser data comprises encrypted volser data.

10. The sheet of claim 8, wherein one RFID tag in the array of RFID tags is attached to a housing of a data storage device, and the volser data uniquely identifies the data storage device.

11. The sheet of claim 8, wherein volser data comprises user specified volser data inkjet printed onto the inkjet receptive surface.

12. The sheet of claim 8, wherein the RFID circuitry comprises a memory chip such that each memory chip of each inkjet printable RFID label is programmed with the volser data printed on the inkjet receptive surface.

13. The sheet of claim 12, wherein the memory chip is programmed to electronically and redundantly store an entirety of data printed to the volser field and the bar code field.

14. The sheet of claim 12, wherein the volser data comprises at least one checking number configured to verify that the volser data is correctly printed, and the memory chip is configured to electronically store the at least one checking number.

15. The sheet of claim 6, wherein the plurality of RFID labels comprises a first inkjet printable RFID label including a first volser field and a second inkjet printable RFID label including a second volser field, the first volser field including a first volser number printed on the inkjet receptive surface and the second volser field including a second volser number printed on the inkjet receptive surface, the first volser number different from the second volser number.

16. A method of inkjet printing an RFID label, the method comprising:
providing an RFID tag including a backing defining a first surface and a second surface, radiofrequency circuitry attached to the second surface and an inkjet receptive laminate attached to the first surface;
inserting the RFID tag into an inkjet printer; and
inkjet printing indicia onto an inkjet receptive surface of the inkjet receptive laminate.

17. The method of claim 16, wherein providing an RFID tag comprises providing a sheet including an array of RFID tags disposed on a liner and label stock disposed over the RFID tags, the label stock including the inkjet receptive laminate.

18. The method of claim 17, wherein inkjet printing indicia onto an inkjet receptive surface comprises inkjet printing a volser number into a volser field and inkjet printing bar code data into a bar code field on the inkjet receptive surface of each RFID tag in the array.

19. The method of claim 18, wherein a first volser number is inkjet printed into the volser field and a first set of bar code data is inkjet printed into the bar code field on a first RFID tag in the array, and a second volser number is inkjet printed into another volser field and a second set of bar code data is inkjet printed into another bar code field on a another RFID tag in the array.

20. The method of claim 19, further comprising:
attaching the first RFID tag to a first data storage device and attaching the second RFID tag to a second data storage device.

21. A sheet including a plurality of volser labels attachable to a data storage cartridge, the sheet comprising:
a release liner; and
volser labels removably coupled to the release liner, each volser label including:
an adhesive in contact with the release liner,
a substrate coupled to the adhesive,
an inkjet receptive surface disposed on the substrate spaced from the adhesive;
wherein the inkjet receptive surface comprises inorganic particles coated onto the substrate to define a porous inkjet receptive surface.

22. The sheet of claim 21, wherein the volser labels are inkjet printed volser labels that comprise at least one field of inkjet printed data storage cartridge data.
